(19) United States
(12) Patent Application Publication
(10) Pub. No.: US 2013/0024101 A1
(43) Pub. Date: Jan. 24, 2013

(54) METHOD TO PERFORM THREAT ANALYSIS AND SYMBOLOGY USING ADS-B TRAFFIC DATA

(71) Applicant: William Thomas DeRouchey, JR., Prescott, AZ (US)

(72) Inventor: William Thomas DeRouchey, JR., Prescott, AZ (US)

(21) Appl. No.: 13/188,368

(22) Filed: Jul. 21, 2011

(51) Int. Cl. G08G 5/04

(52) U.S. Cl. 701/121; 701/120

(57) ABSTRACT

This method utilizes an aircraft cockpit computer to calculate in real time the closest point of approach and time to this three dimensional point then depict the future situation to the pilot on a cockpit display using new symbols and textual information.

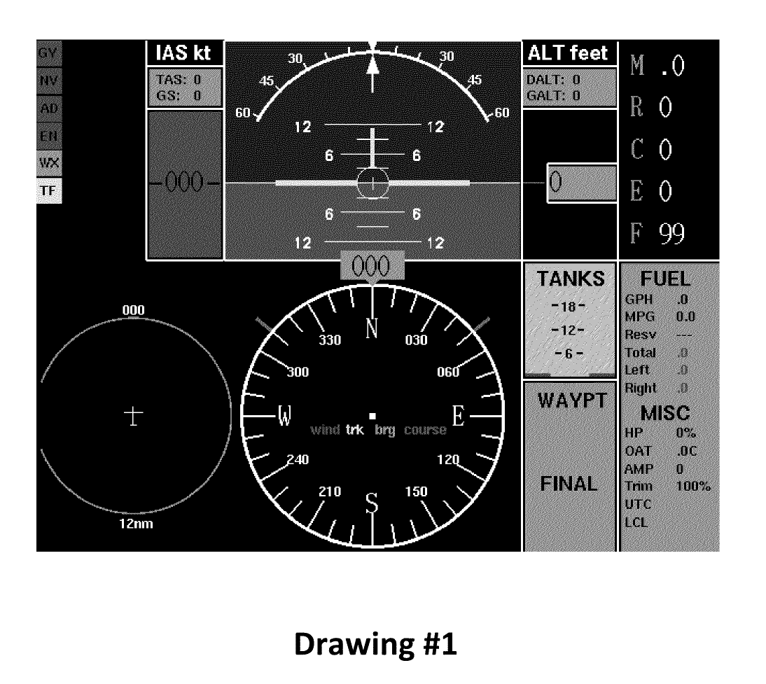

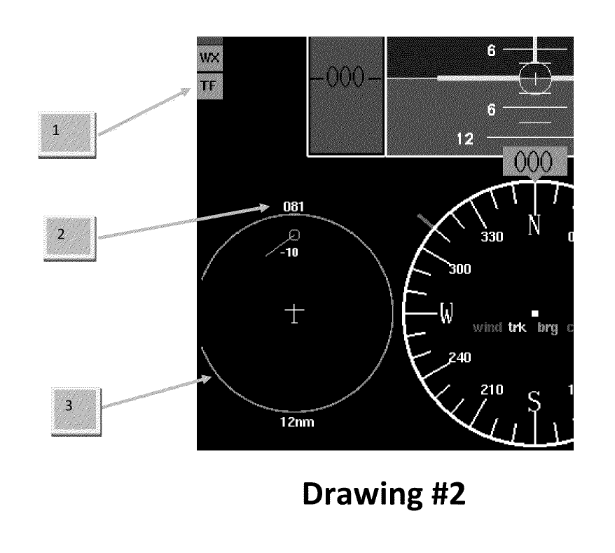

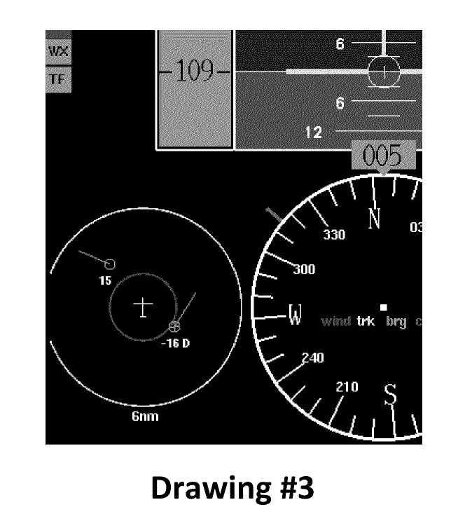

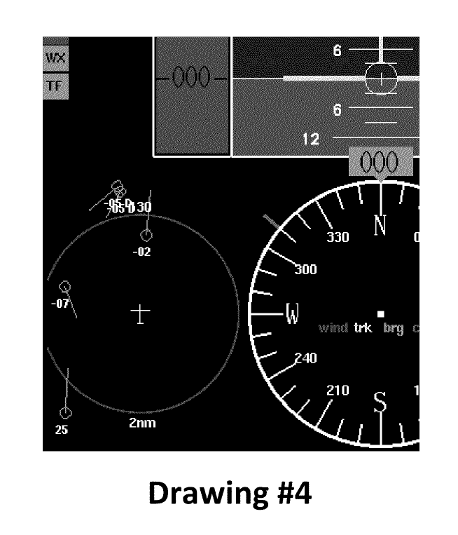

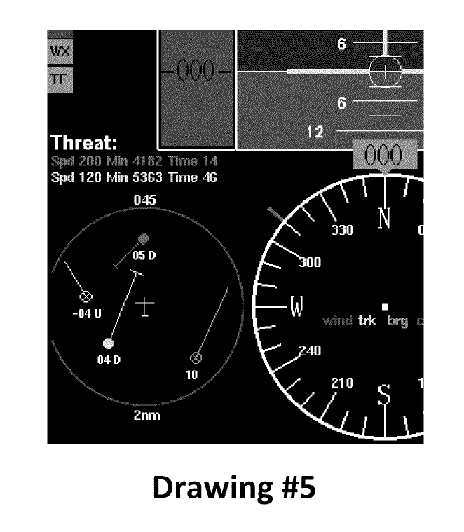

### BACKGROUND

Aircraft mid-air collisions cannot be predicted very well by a pilot. In the early days of aviation there was a large volume of air and few planes, so the probability of a collision was low. Looking vigilantly out the window was helpful but there are several aircraft trajectories that cannot be viewed by either pilot. As the volume of air remained constant and the number of aircraft dramatically increased radar and other electronic approaches were developed to forewarn pilots.

Traffic Collision Avoidance System (TCAS) that is in service today was developed for commercial airlines. It is inaccurate, controls each aircraft on the vertical axis only, and does not coordinate well with Air Traffic Control (ATC). In addition, it is prohibitively expensive for General Aviation (GA) aircraft. General Aviation aircraft fly in a layer below Commercial aircraft so Commercial aircraft must ascend and descend through the General Aviation aircraft for each flight. This produces an unusual situation where one aircraft is using TCAS, and the other perhaps just looking out the window.

A more economical approach for GA, named TIS-A, was created that transmitted radar contacts to all aircraft equipped with Mode S transponders. This useful, but short-sighted system has all the inaccuracies of radar and was only enabled around a few metropolitan areas. It was too expensive to be deployed throughout a large geographic area.

Automated Dependent Surveillance Broadcast (ADS-B) has been developed to create an inexpensive data link that broadcasts GPS position, velocity vector, and identification of your aircraft (Ownship) to other aircraft and ground stations. ADS-B dramatically improves accuracy, minimizes expense, and provides a homogenous air traffic surveillance system enabling a computerized ATC in the future. It is currently being deployed across the United States and other countries.

One feature that is provided in TCAS and missing in ADS-B is an affordable method to prioritize threats in high traffic areas. A GA pilot must perform many tasks simultaneously and if he devotes all his attention to watching traffic other safety issues may arise that go unnoticed. This invention is directed to depicting the future traffic situation and prioritizing those threats, which enables the pilot to make evasive maneuvers quicker while interweaving other tasks.

There are several existing patents that address traffic threats and provide avoidance commands. The implementation of these commands may be ordering a pilot to maneuver his aircraft as in TCAS, or directly steering unmanned aircraft. These approaches are not viable for GA because they do not take into consideration the wide variety of GA aircraft and conditions prevalent when flying at lower altitudes. For example, the avoidance commands could steer the GA aircraft in a manner that would be structurally unsafe. Or, steer the aircraft into terrain or adverse weather.

The mathematical basis chosen for this method to project multiple aircraft trajectories into the future is named Closest Point of Approach (CPA). It is a well defined three dimensional vector calculation that provides minimum distance between paths, where in space the CPA occurs, and when it will occur. It exists in the public domain, and therefore, is not presented herein.

### DESCRIPTION OF DRAWINGS

This sequence of drawings depicts the traffic symbology from no threat to multiple priority threats. Drawing #1 shows a complete Primary Flight Display to provide an overall sense of what the pilot might see, however, only the area of the display with the traffic content is discussed.

See Drawing #2 item 1. “TF” is yellow if no traffic packets are flowing and green if traffic packets are being received. Green means that the pilot will see at least one intruder plotted on the graphic display.

See Drawing #2 item 2. This number is the rotation used to orient the traffic display. When Ownship is taxiing this number is the aircraft Yaw, and when flying is disappears and rotation becomes the Ownship track. Two GPS points are necessary to provide track and when Ownship is stopped on the ground the track is not valid. This convention lets the pilot observe traffic relative to the nose of his aircraft while taxiing or running up the engine.

See Drawing #2 item 3. The range rings automatically scale and change color from green to yellow to red to depict ranging from 12 nautical miles (nm) to 6 nm to 2 nm.

The track indicator line of the threat aircraft is length normalized to the cruise speed of Ownship and indicates the direction the threat aircraft is traveling relative to the direction of Ownship. This is called “track up” and it simplifies where the pilot can visually locate the threat relative to the nose of his aircraft. A short track indicator line indicates a helicopter or other slow aircraft and a long track indicator indicates a fast moving aircraft to give the pilot an additional sense of priority.

Drawing #1 depicts a typical cruise with no traffic present. Note that the range ring is at its maximum and no traffic is shown. Also, the yellow “TF” annunciator shows ADS-B is not reporting traffic within the outer containment cylinder.

Drawing #2 depicts the first intruder aircraft that that has ventured within the outer containment cylinder. The “TF” annunciator has turned green indicating that traffic packets are present. Traffic is located directly in the path of Ownship, is 1000 feet lower, flying level, and moving to the pilots left about the same speed as Ownship.

Drawing #3 shows the next level of escalation depicting all threat traffic between inside the yellow 6 nm ring. Traffic at upper left is 1500 feet higher and flying level to the left away from Ownship. Traffic at lower right is 1600 feet lower than Ownship and descending.

Drawing #4 shows many targets in the immediate area as one might see when approaching an airport but none are high priority. The target directly in front of Ownship, moving approximately the same speed as Ownship and 200 feet below would be under the nose and difficult to see visually.

Drawing #5 shows two targets have advanced to priority threats. The magenta target is the highest priority threat and will close to 4182 feet in 14 seconds. Visually it looks very dangerous because it is directly in front and above Ownship, descending and moving fast. However, the closest point of approach is 4182 feet and this threat will move to the left and away from Ownship very quickly. Ownship should have no difficulty visually identifying this threat.

The second high priority threat in Drawing #5 is the yellow aircraft that is slowly overtaking. Ownship will probably be well ahead when it arrives from the 7 o'clock position in 46 seconds but with the threat descending an increase in speed could easily create a dangerous situation. Note that neither aircraft can see the other. From this information Ownship should turn 20 degrees right and avoid all the traffic depicted.

In 14 seconds the magenta threat will have crossed through the CPA point and the distance between aircraft will increase. This threat will be downgraded to a normal threat and colored green at that time. The yellow threat will advance to the highest priority threat and colored magenta.

1. Method uses well known Closest Point of Approach (CPA) three dimensional mathematical formulas to predict future air traffic situations and project them on a two dimensional cockpit graphic display using new symbols.

2. The method of claim 1 further comprises graphic information displayed is at least Ownship, threat location, threat direction, and point where CPA is located. The new symbols are an extension of TCAS symbols currently used in aircraft traffic displays. TCAS symbology is not claimed but used here to remain consistent with current pilot experience.

3. The method of claim 1 further comprises textual information that lists priority threats and at least the time to CPA, distance between Ownship and threat aircraft at the CPA, and the speed of the threat.

4. The method of claim 1 further comprises that all traffic packets that describe the airspace around Ownship arrive within at least a one second window from the ADS-B receiver and all threat analysis calculations, the graphic traffic depiction, and the textual information are updated each second.

5. The method of claim 1 further comprises pre-determined volumes of airspace defined for a class of aircraft and typically based upon the Ownship aircraft speed. The outer volume defines the first level of an intruder to create an interest level of the Ownship pilot. This filter may be located in the ADS-B receiver itself and as an example is preset to a cylinder of 12 nm radius and 3000 feet above and 3000 feet below Ownship. When an intruder aircraft travels inside the cylinder it is first displayed. As the intruder moves closer to Ownship it becomes a threat, and range rings are automatically adjusted to escalate pilot interest and further filter the potential threats.

6. The method of claim 1 further comprises a definition of high threat space; that is, those aircraft that are located, for example, in spherical volume 1.5 nm miles from Ownship. CPA calculations are performed on all aircraft within this high threat space to determine the CPA location, minimum distance between aircraft at the CPA, and time in seconds until Ownship is at CPA.

7. The method of claim 6 further comprises sorting those aircraft processed into a list with least time to CPA being the highest threat. At least the two highest threats are defined as priority threats.

8. The method of claim 6 further comprises the graphics and textual information for the two priority threats are depicted in colors different than those chosen for other less threatening aircraft. The textual information of a given color is matched to the graphic aircraft of the same color.

9. The method of claim 1 further comprises a graphic track indicator that is a line extended from the threat aircraft immediate location to the future CPA threat location for those two priority threats identified in claim 6. A small cross marks the CPA at the end of the graphic track indicator.

10. The method of claim 1 further comprises a graphic track indicator for those threats not determined to be priority threats by claim 6. The length of the graphic track indicator is relative to a pre-defined cruise speed of Ownship. The angle of the graphic track indicator is relative to the direction of Ownship.

11. The method of claim 1 further comprises the priority threat aircraft identified by claim 6 are re-classified to a normal threat when:
a) The CPA time calculation becomes negative indicating the CPA occurred in the past.
b) CPA time is very large indicating that the threat aircraft and Ownship are on or close to parallel courses.
c) The distance from Ownship to the threat aircraft CPA is outside the high threat space defined in claim 6.

12. The method of claim 1 further comprises at least display indicators, aural, and warning lights are present to alert the pilot that traffic threats are present. For example, Drawing #2 item 1 “TF” is yellow when ADS-B receiver is functioning correctly and no threats are within the outer volume described in claim 5 and green when there is at least one threat aircraft within the volume described in claim 5.

13. The method of claim 1 further comprises a number that is the rotation used to orient the traffic display. See Drawing #2 item 2. It is normally the Ownship yaw when Ownship is moving slowly on the ground. Once Ownship is moving, for example 5 mph, this number is omitted and the rotation becomes the Ownship track.
